(19) United States
(12) Patent Application Publication
(10) Pub. No.: US 2025/0236921 A1
(43) Pub. Date: Jul. 24, 2025

(54) METHOD OF MANUFACTURING METAL MEMBER

(71) Applicant: FUTABA INDUSTRIAL CO., LTD., Okazaki-shi (JP)

(72) Inventors: Hiromu Nakao, Okazaki-shi (JP); Hiroaki Fujitake, Okazaki-shi (JP)

(21) Appl. No.: 19/001,730

(22) Filed: Dec. 26, 2024

(30) Foreign Application Priority Data
Jan. 24, 2024 (JP) 2024-008674

(51) Int. Cl. C21D 1/34; B23K 26/352

(52) U.S. Cl. CPC C21D 1/34; B23K 26/352

(57) ABSTRACT

In a method of manufacturing a metal member, a beam is radiated towards a ridgeline part in an outer surface of the metal member in order to perform quenching. The ridgeline part extends along a ridgeline in the outer surface. The ridgeline part has a cross-section orthogonal to the ridgeline. The cross-section has a shape such that the outer surface is bent in a protruding manner. The ridgeline is located at a top in the cross-section. An irradiation area irradiated with the beam moves on an irradiation path that passes through the ridgeline part. The irradiation path includes at least one intersecting section intersecting the ridgeline. As a distance between the irradiation area and a light source of the beam increases, a moving speed of the irradiation area is slowed down.

### CROSS-REFERENCE TO RELATED APPLICATIONS

The present application claims the benefit of Japanese Patent Application No. 2024-008674 filed on Jan. 24, 2024 with the Japan Patent Office, the disclosure of which is incorporated herein in its entirety by reference.

### BACKGROUND

The present disclosure relates to a method of manufacturing a metal member.

There have been known techniques for performing quenching by radiating a beam towards an outer surface of a workpiece (for example, see Japanese Unexamined Patent Application Publication No. H10-176216). In the technique of Patent Document 1, the beam is radiated along a part of the workpiece extending in the form of a ridgeline (hereinafter, “ridgeline part”), whereby quenching is performed.

### SUMMARY

However, during radiation of the beam, heat dissipation cannot be adequately carried out in the ridgeline part of the workpiece compared to a peripheral part of the workpiece adjacent to the ridgeline part. For this reason, the ridgeline part of the workpiece tends to be heated at a high temperature, which poses a difficulty in heating the ridgeline part and the peripheral part uniformly. In particular, when a light source of the beam is positioned in front of the ridgeline part, the ridgeline part is easily overheated. As a result, there is a possibility where a damage such as a burn-through occurs in the ridgeline part and the peripheral part cannot be heated sufficiently.

Moreover, when an irradiation area of the beam is moved so as to intersect the ridgeline part, there is a possibility where a distance between the light source of the beam and the irradiation area of the beam is changed. As a result, there is a possibility where a part of the workpiece close to the light source of the beam is overheated and a part of the workpiece distal to the light source of the beam cannot be heated sufficiently.

In one aspect of the present disclosure, it is desirable to encourage more uniform heating during quenching.

One aspect of the present disclosure provides a method of manufacturing a metal member. The method comprises radiating a beam towards a ridgeline part in an outer surface of the metal member in order to perform quenching. The ridgeline part extends along a ridgeline in the outer surface. The ridgeline part has a cross-section orthogonal to the ridgeline. The cross-section has a shape such that the outer surface is bent in a protruding manner. The ridgeline is located at a top in the cross-section. An irradiation area irradiated with the beam moves on the irradiation path that passes through the ridgeline part. The irradiation path includes at least one intersecting section intersecting the ridgeline. As a distance between the irradiation area and a light source of the beam increases, a moving speed of the irradiation area is slowed down.

The above configuration can reduce overheating of a portion of the metal member near the light source of the beam and insufficient heating of a portion of the metal member away from the light source of the beam. Thus, the above configuration can help achieve more uniform heating during quenching.

One aspect of the present disclosure provides a method of manufacturing a metal member. The method comprises radiating a beam towards a ridgeline part in an outer surface of the metal member in order to perform quenching. The ridgeline part extends along a ridgeline in the outer surface. The ridgeline part has a cross-section orthogonal to the ridgeline. The cross-section has a shape such that the outer surface is bent in a protruding manner. The ridgeline is located at a top in the cross-section. An irradiation area irradiated with the beam moves on an irradiation path that passes through the ridgeline part. The irradiation path includes at least one of intersecting section intersecting the ridgeline. As a distance between the ridgeline and the irradiation area increases, a moving speed of the irradiation area is slowed down.

The above configuration can reduce overheating of the portion of the metal member near the ridgeline and insufficient heating of the portion of the metal member away from the ridgeline. Thus, the above configuration can help achieve more uniform heating during quenching.

In one aspect of the present disclosure, the irradiation path may include at least one first intersecting section, which is included in the at least one intersecting section; and at least one second intersecting section, which is included in the at least one intersecting section. The at least one first intersecting section and the at least one second intersecting section may be aligned alternately from a starting point to an ending point of the irradiation path. Each first intersecting section of the at least one first intersecting section may include a first starting end located on right of the ridgeline; and a first terminating end located on left of the ridgeline. Each second intersecting section of the at least one second intersecting section may include a second starting end located on the left of the ridgeline; a second terminating end located on the right of the ridgeline. The irradiation area may move from the first starting end to the first terminating end of the each first intersecting section of the at least one first intersecting section, and move from the second starting end to the second terminating end of each second intersecting section of the at least one second intersecting section. Upon arriving at the first terminating end of a first intersecting section included in the at least one first intersecting section, the irradiation area may move to the second starting end of a second intersecting section included in the at least one second intersecting section that is adjacent to the first intersecting section on an ending point-side. Upon arriving at the second terminating end of the second intersecting section, the irradiation area may move to the first starting end of an other first intersecting section included in the at least one first intersecting section that is adjacent to the second intersecting section on the ending point-side.

The above configuration can help achieve more uniform heating during quenching.

In one aspect of the present disclosure, an area through which the irradiation area passes may be defined as a passage area. The passage area may include a first passage area formed by the irradiation area passing through the first intersecting section, and a second passage area formed by the irradiation area passing through the second intersecting section adjacent to the first intersecting section. A size of the irradiation area and a distance between the first intersecting section and the second intersecting section adjacent to each other may be adjusted so that the first passage area and the second passage area overlap.

According to the above configuration, the metal member can be more reliably heated during quenching.

In one aspect of the present disclosure, the irradiation path may include two or more first intersecting sections as the at least one first intersecting section; and two or more second intersecting sections as the at least one second intersecting section.

The above configuration can help achieve more uniform heating during quenching.

In one aspect of the present disclosure, the at least one first intersecting section and the at least one second intersecting section may be aligned substantially parallelly with a substantially constant interval therebetween.

The above configuration can help achieve more uniform heating during quenching.

In one aspect of the present disclosure, the at least one intersecting section may be substantially orthogonal to the ridgeline.

The above configuration can help achieve more uniform heating during quenching.

In one aspect of the present disclosure, the irradiation area may move through the at least one intersecting section by changing a radiation direction of the beam with a mirror.

According to the above configuration, the beam can be more favorably radiated along the at least one intersecting section.

In one aspect of the present disclosure, the ridgeline part may be located in a plate-like part of the metal member. The at least one intersecting section may be provided so as to cross a portion of the plate-like part that forms an effective width.

The above configuration can help achieve more uniform heating of the portion of the plate-like part that forms the effective width. Accordingly, quenching can be performed while a damage of the metal member is reduced.

In one aspect of the present disclosure, the metal member may be formed by press-forming and used for a body of a vehicle.

The above configuration can help achieve more uniform heating during quenching.

### BRIEF DESCRIPTION OF THE DRAWINGS

Embodiments of the present disclosure will be described hereinafter with reference to the accompanying drawings, in which:

FIG. 1 is a perspective view of a metal member according to a first embodiment;

FIG. 2 is a diagram explaining radiation of a beam on the metal member from a laser head in the first embodiment, as viewed in a direction towards a ridgeline;

FIG. 3 is a diagram explaining the radiation of the beam on the metal member from the laser head in the first embodiment, as viewed from a first side part of the metal member;

FIG. 4 is a diagram explaining an irradiation area and an irradiation path in the first embodiment;

FIG. 5 is a diagram explaining the irradiation area, the irradiation path, and a passage area in the first embodiment;

FIG. 6 is a diagram explaining an irradiation area and an irradiation path in a second embodiment; and

FIG. 7 is a diagram explaining radiation of the beam on the metal member from the laser head in the second embodiment, as viewed in the direction towards the ridgeline.

### DETAILED DESCRIPTION OF EXEMPLARY EMBODIMENTS

### 1. First Embodiment

### [(1) Overview]

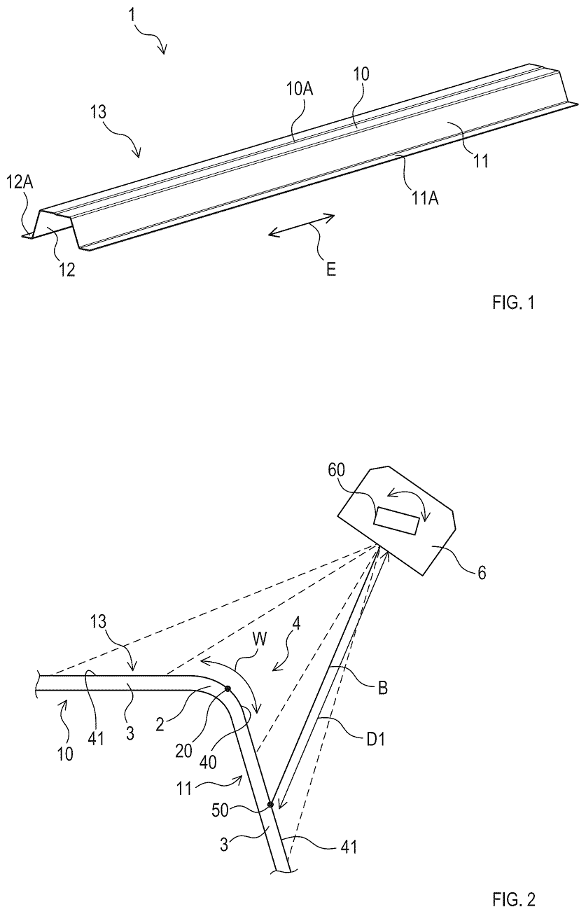

A method of manufacturing a metal member 1 (see, FIG. 1) in a first embodiment includes a process of performing quenching of the metal member 1 with a beam. The metal member 1 is in the form of a plate and made of metal (iron, in one example). In one example, a material forming the metal member 1 may be high-tensile steel, and more specifically, high-tensile steel with a tensile strength of 590 MPa or more. Furthermore, in one example, the metal member 1 is used as a part of a vehicle, and more specifically, a part of a body of the vehicle. Needless to say, the metal member 1 is not limited hereto, and may be a member that is not mounted on the vehicle.

The metal member 1 is in the form of a groove extending along an extending direction E. The metal member 1 comprises a top part 10, a first side part 11, a first flange part 11A, a second side part 12, and a second flange part 12A (see, FIGS. 1 and 2).

The top part 10 is in the form of an elongated plate that extends in the extending direction E in a planar manner. In a center of the top part 10 in its width direction, a step portion 10A extending in the extending direction E is formed.

The first and second side parts 11 and 12 are in the form of plates protruding from both edges of the top part 10 in the width direction. The first and second side parts 11 and 12 face each other in the width direction of the top part 10. Each of the first and second side parts 11 and 12 extends from a first end to a second end of the top part 10 in the extending direction E.

The first and second flange parts 11A and 12A are in the form of flanges provided at respective ends of the first and second side parts 11 and 12 opposite to the top part 10. Both of the first and second flange parts 11A and 12A extend from respective first ends to respective second ends of the first and second side parts 11 and 12 in the extending direction E.

In other words, the first and second side parts 11 and 12 form an opening of the metal member 1, which is in the form of a groove; and the first and second flange parts 11A and 12A are arranged on both sides defining the opening. A surface of the top part 10 and surfaces of the first and second side parts 11 and 12, opposite to the opening, form an outer surface 13 of the metal member 1.

### [(2) Ridgeline Part and Peripheral Portions]

At a boundary between the top part 10 and the first side part 11, there is provided a ridgeline part 2 (see, FIGS. 1 and 2) extending linearly along a ridgeline 20. The ridgeline 20 extends linearly along the extending direction E and is included in the ridgeline part 2. Moreover, the ridgeline part 2 and the ridgeline 20 extend from a first end to a second end of the metal member 1.

The ridgeline part 2 has a cross-section orthogonal to the ridgeline 20 (hereinafter, simply referred to as “cross-section”). The cross-section has a shape such that the outer surface 13 of the metal member 1 is bent in a protruding manner. In the first embodiment, as one example, the entire cross-section of the ridgeline part 2 is shaped in a curving manner (see, FIG. 2). However, the cross-section of the ridgeline part 2 is not limited hereto, and may include a curved part and a part extending in a planar manner, or may have a bent shape. The ridgeline 20 is located at a top in the cross-section.

Furthermore, in a ridgeline width direction W, the ridgeline part 2 has a length substantially corresponding to von Karman's effective width be of the metal member 1. The ridgeline width direction W is a direction along the outer surface 13 and orthogonal to the extending direction E. The effective width be can be calculated in accordance with, for example, the formula below.

$$be = \sqrt{\frac{{π}^{2} Ek}{12 ( 1 - {γ}^{2} ) {σ}_{y}}} \times t$$

It should be noted that “E” represents Young's modulus of metal that forms the metal member 1; “k” represents the constraint factor; “v” represents Poisson's ratio; “σ_{y}” represents the yield point (MPa); and “t” represents the thickness (mm) of the metal member 1. Needless to say, the length of the ridgeline part 2 in the ridgeline width direction W is not limited to the effective width be, and can be appropriately determined.

Furthermore, a portion of the top part 10 adjacent to the ridgeline part 2 and a portion of the first side part 11 adjacent to the ridgeline part 2 are referred to as “peripheral portions 3”. Specifically, the peripheral portions 3 include two portions located on both the left and the right of the ridgeline part 2. The peripheral portions 3 have cross-sections expanding in a planar manner. The peripheral portions 3 also extend from the first end to the second end of the metal member 1.

### [(3) Method of Manufacturing Metal Member]

The method of manufacturing the metal member 1 includes a process of forming the metal member 1 by press-forming and a process of performing quenching of the metal member 1 (hereinafter, appropriately referred to as “quenching process”) (see, FIGS. 2 to 5). It should be noted that the metal member 1 may be formed by a method different from the press-forming.

In the quenching process, a beam B is radiated towards a quenching area 4, which is provided in an area of the outer surface 13 of the metal member 1 where the ridgeline part 2 and the peripheral portions 3 are located. In one example, the quenching area 4 is heated at approximately 900° C.

The location, shape, and size of the quenching area 4 are appropriately determined. In one example, the quenching area 4 extends so as to include the ridgeline part 2, and the peripheral portions 3 on both the left and the right of the ridgeline part 2. However, the quenching area 4 is not limited hereto, and may be provided in the ridgeline part 2, or in the ridgeline part 2 and one of the peripheral portions 3. In addition, the quenching area 4 extends in a direction along the ridgeline 20 in the form of a strip. The quenching area 4 has a substantially constant width, and the ridgeline 20 is located substantially at a center of the quenching area 4 in its width direction. In addition, both ends of the quenching area 4 in the ridgeline width direction W extend linearly along the ridgeline 20. Furthermore, after radiation of the beam B on the quenching area 4 is complete, the beam B may be additionally radiated on an area in the outer surface 13 different from the quenching area 4.

After heating of the metal member 1 with the beam Bis complete, the metal member 1 is rapidly cooled to, in one example, approximately 200° C. within a short period of time. Consequently, the martensitic transformation occurs in the quenching area 4 of the metal member 1, whereby hardness of the quenching area 4 is improved.

### [(4) Irradiation Path]

In the quenching process, the beam B is radiated along an irradiation path 5 set in the quenching area 4 (see, FIG. 4). The irradiation path 5 is arranged across the entire quenching area 4, and includes two or more first intersecting sections 51, two or more second intersecting sections 52, and two or more connecting sections 53.

The first and second intersecting sections 51 and 52 (hereinafter, simply referred to as “intersecting section(s)”) intersect the ridgeline 20, and are aligned alternately from a starting point 5S to an ending point 5E of the irradiation path 5. In one example, each intersecting section extends linearly so as to intersect the ridgeline 20 at substantially 90 degrees. Each intersecting section has substantially the same length. Ends of each intersecting section are located in the peripheral portions 3 on both the left and the right of the ridgeline part 2, adjacent to the ends of the quenching area 4. In other words, each intersecting section crosses a portion of the metal member 1 forming the effective width be, and the both ends thereof are located at portions of the metal member 1 different from the portion forming the effective width be. The intersecting sections are aligned substantially parallelly from the starting point 5S to the ending point 5E of the irradiation path 5 at substantially constant intervals (hereinafter, “pitch(es) P”) along the ridgeline 20.

However, the present disclosure is not limited hereto, and the intersecting angle between each intersecting section and the ridgeline 20, the length of each intersecting section, the shape of each intersecting section, the location of each intersecting section, or the pitch P can be appropriately determined in accordance with, for example, the shape of the metal member 1 (more specifically, the ridgeline part 2) and/or the shape of the quenching area 4. Furthermore, the irradiation path 5 may have a single first intersecting section 51 and a single second intersecting section 52. Still further, the ends of each intersecting section are not necessarily located in the peripheral portions 3, and may be located on the left or the right of the ridgeline 20 in the ridgeline part 2.

Each first intersecting section 51 includes a first starting end 51S, which is located on the right of the ridgeline 20; and a first terminating end 51E, which is located on the left of the ridgeline 20. In addition, each second intersecting section 52 includes a second starting end 52S, which is located on the left of the ridgeline 20; and a second terminating end 52E, which is located on the right of the ridgeline 20.

Moreover, on the left of the ridgeline 20, the first terminating end 51E of the first intersecting section 51 and the second starting end 52S of the second intersecting section 52 that is adjacent to the first intersecting section 51 on its ending point 5E-side are connected to each other via each connecting section 53. On the right of the ridgeline 20, the second terminating end 52E of the second intersecting section 52 and the first starting end 51S of the first intersecting section 51 that is adjacent to the second intersecting section 52 on its ending point 5E-side are connected to each other via each connecting section 53.

In one example, the first starting end 51S of the first intersecting section 51 is located at the starting point 5S of the irradiation path 5. However, the present disclosure is not limited hereto. At the starting point 5S, the second starting end 52S of the second intersecting section 52 may be located. In one example, the second terminating end 52E of the second intersecting section 52 is located at the ending point 5E of the irradiation path 5. However, the present disclosure is not limited hereto. At the ending point 5E, the first terminating end 51E of the first intersecting section 51 may be located.

### [(5) Radiation of Beam]

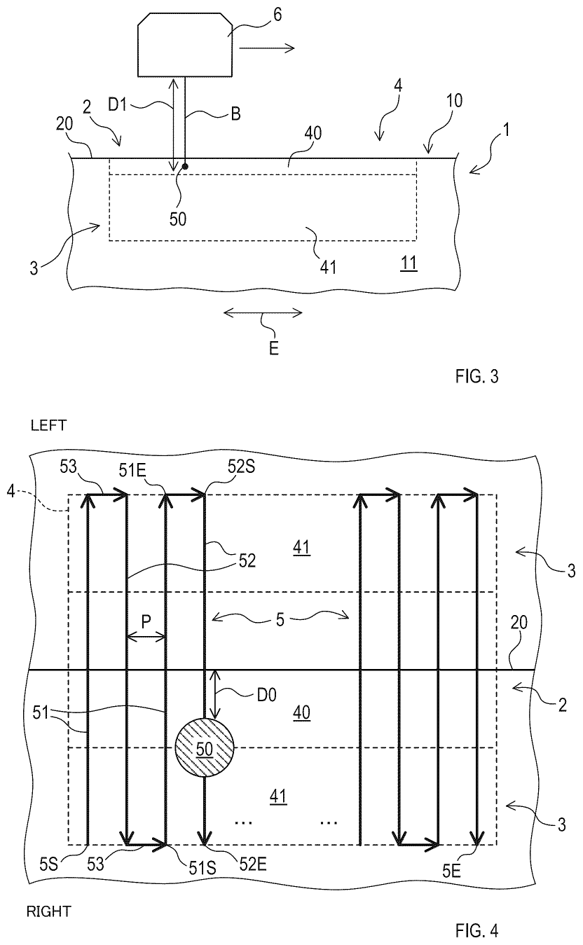

In the quenching process, the beam B is radiated from a laser head 6 of a laser device towards the irradiation path 5 in the quenching area 4 (see, FIGS. 2 and 3). A radiation direction of the beam B, and positions of a light source of the beam B and the metal member 1 relative to each other are adjusted so that an irradiation area 50, which is irradiated with the beam B, moves on the irradiation path 5 from the starting point 5S to the ending point 5E of the irradiation path 5 (see FIG. 4). In one example, the irradiation area 50 is circular, and a center of the irradiation area 50 passes on the irradiation path 5. However, the shape of the irradiation area 50 is not limited hereto, and can be appropriately determined.

Specifically, when the irradiation area 50 moves through the intersecting section, the radiation direction of the beam B is changed by adjusting an orientation of a Galvano mirror 60 provided in the laser head 6. As a result, the irradiation area 50 moves from the first starting end 51S to the first terminating end 51E through the first intersecting section 51, and moves from the second starting end 52S to the second terminating end 52E through the second intersecting section 52.

When the irradiation area 50 moves through the connecting section 53, the laser head 6 and/or the metal member 1 is moved in the direction along the ridgeline 20. As a result, the irradiation area 50 moves through the connecting section 53 from the first terminating end 51E of the first intersecting section 51 to the second starting end 52S of the second intersecting section 52, and moves through the connecting section 53 from the second terminating end 52E of the second intersecting section 52 to the first starting end 51S of the first intersecting section 51.

Needless to say, the present disclosure is not limited hereto. For example, the irradiation area 50 may be moved through the intersecting section by moving the laser head 6 configured as a Galvano head and/or the metal member 1. For example, the irradiation area 50 may be moved through the connecting section 53 by changing the radiation direction of the beam B with the Galvano mirror 60.

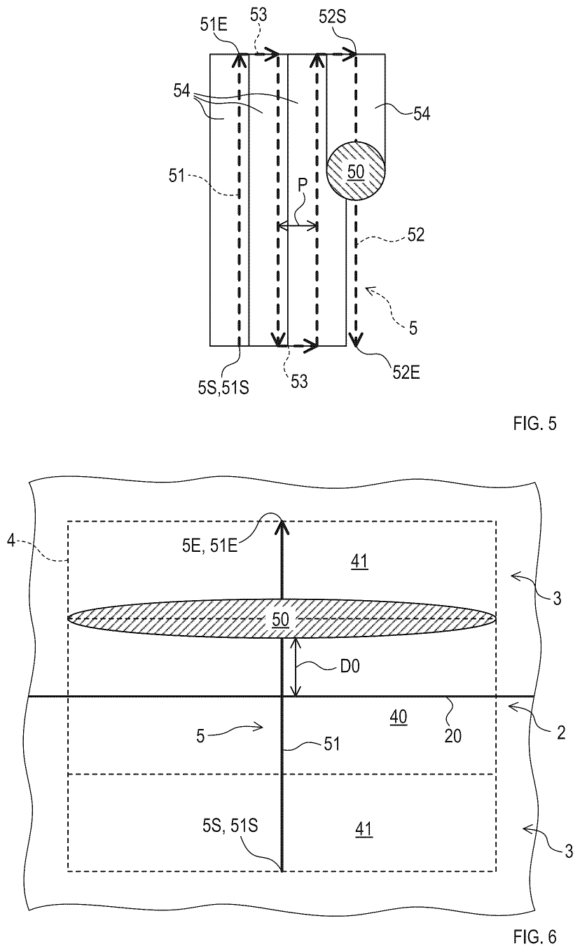

The size of the pitch P and the size of the irradiation area 50 (the diameter of the irradiation area 50, in one example) are set so that a first passage area 54 and a second passage area 54 overlap (see, FIG. 5). The first passage area 54 is formed by the irradiation area 50 passing through the first intersecting section 51; and the second passage area 54 is formed by the irradiation area 50 passing through the second intersecting section 52 adjacent to the first intersecting section 5. The passage areas 54 mean areas through which the irradiation area 50 passes. In one example, the pitch P may be 0.05 mm or more and 0.15 mm or less. The diameter of the irradiation area 50 may be about 5 mm or more.

### [(6) Moving Speed of Irradiation Area]

In one example, the laser head 6 is arranged so that the light source of the beam B is positioned in front of the ridgeline 20 of the metal member 1 (see, FIG. 2). More specifically, the laser head 6 may be arranged so that the light source of the beam B is brought closest to the ridgeline 20, in one example.

A speed at which the radiation direction of the beam B changes and a moving speed(s) of the laser head 6 and/or the metal member 1 are adjusted so that a moving speed of the irradiation area 50 during its movement on the irradiation path 5 is slowed down as a ridgeline distance DO (see, FIG. 4) increases. The ridgeline distance DO means a distance between the ridgeline 20 and the irradiation area 50.

Moreover, a speed at which the radiation direction of the beam B changes and the moving speed(s) of the laser head 6 and/or the metal member 1 are adjusted so that the moving speed of the irradiation area 50 during its movement on the irradiation path 5 is slowed down as a light source distance D1 (see, FIGS. 2 and 3) increases. The light source distance D1 means a distance between the light source of the beam B in the laser head 6 and the irradiation area 50.

In the first embodiment, in one example, there are two levels of moving speeds. Specifically, the quenching area 4 includes a high-speed area 40 and two low-speed areas 41. The high-speed area 40 contains the ridgeline 20. The high-speed area 40 extends along the ridgeline 20 from the first end to the second end of the quenching area 4. The high-speed area 40 has a substantially constant width, and the ridgeline 20 is located substantially at a center of the high-speed area 40 in its width direction. The low-speed areas 41 are located on both the left and the right of the high-speed area 40, and extend from the first end to the second end of the quenching area 4. The low-speed areas 41 extend so as to include the ends of the quenching area 4 in a direction along the intersecting section, and have substantially the same width.

That is, when the irradiation area 50 moves on the irradiation path 5 located in the low-speed areas 41, the distance (that is, the ridgeline distance DO) between the irradiation area 50 and the ridgeline 20 and the distance (that is, the light source distance D1) between the irradiation area 50 and the light source of the beam B are long, as compared to when the irradiation area 50 moves on the irradiation path 5 located in the high-speed area 40. The moving speed of the irradiation area 50 during its passage through the high-speed area 40 is faster than the moving speed of the irradiation area 50 during its passage through the low-speed areas 41. In one example, the moving speed of the irradiation area 50 in the high-speed area 40 is 8000 mm/s; and the moving speed of the irradiation area 50 in the low-speed areas 41 is 4000 mm/s.

Needless to say, the present disclosure is not limited hereto. For example, there may be N (an integer equal to or greater than three) levels of moving speeds. As described above, there may be provided a high-speed area containing the ridgeline 20; and on both sides adjacent to the high-speed area, there may be provided a certain number of low-speed areas, which corresponds to N reduced by one. The moving speed of the irradiation area 50 during its passage through the low-speed areas may be determined in advance, and the farther away from the light source of the beam B or the ridgeline 20 (in other words, the high-speed area) in the low-speed areas, the slower the moving speed of the irradiation area 50 may be set.

Furthermore, for example, the high-speed area and the low-speed areas are not necessarily provided. Specifically, as the light source distance D1 increases or the ridgeline distance DO increases, the moving speed of the irradiation area 50 may be gradually slowed down.

### 2. Second Embodiment

A method of manufacturing the metal member 1 in a second embodiment is different from the first embodiment in respect of the shape of the irradiation area 50 (see, FIG. 6). Hereinafter, a description is given to differences from the first embodiment in the method of manufacturing the metal member 1 according to the second embodiment.

The irradiation area 50 in the second embodiment has an elongated shape extending in the direction along the ridgeline 20. In one example, the irradiation area 50 is in a substantially oval shape. However, the shape of the irradiation area 50 is not limited hereto, and may be a substantially rectangular shape, for example. The irradiation area 50 extends from the first end to the second end of the quenching area 4 in the direction along the ridgeline 20.

Although the irradiation path 5 is also set in the quenching area 4 in the second embodiment, the irradiation path 5 in the second embodiment consists of a single first intersecting section 51. This single first intersecting section 51 is provided substantially at a center of the quenching area 4 in the direction along the ridgeline 20 and configured in a similar manner as in the first embodiment. Specifically, in one example, the first intersecting section 51 extends linearly so as to intersect the ridgeline 20 at approximately 90 degrees. In the first intersecting section 51, the first starting end 51S and the first terminating end 51E, which correspond to the starting point 5S and the ending point 5E of the irradiation path 5, respectively, are located near the ends of the quenching area 4.

In the quenching process, the beam B is radiated across the entire quenching area 4 by moving the irradiation area 50 on the irradiation path 5 from the first starting end 51S to the first terminating end 51E of the first intersecting section 51. At this time, as in the first embodiment, the moving speed of the irradiation area 50 is slowed down as the ridgeline distance DO increases; and the moving speed of the irradiation area 50 is slowed down as the light source distance D1 increases. Specifically, for example, there may be provided a high-speed area and low-speed areas as in the first embodiment, and the irradiation area 50 may be moved at a moving speed suitable for each area.

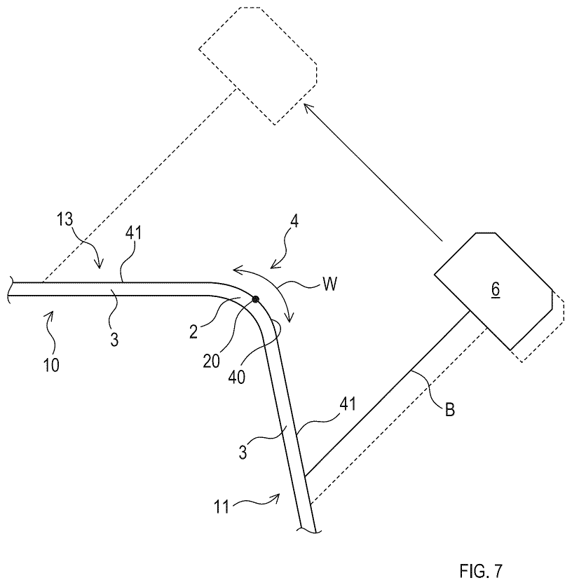

Furthermore, during the movement of the irradiation area 50 on the irradiation path 5, the irradiation area 50 is in a state of extending in a direction orthogonal to the first intersecting section 51. In one example, the irradiation area 50 may be moved by moving the laser head 6 and/or the metal member 1 (see, FIG. 7). Needless to say, the present disclosure is not limited hereto. For example, the irradiation area 50 may be moved by changing the radiation direction of the beam B with the Galvano mirror 60.

It should be noted that the irradiation path 5 may include two or more (several, in one example) intersecting sections and the same connecting sections as in the first embodiment. As in the first embodiment, the beam B may be radiated so that the irradiation area 50 moves on the irradiation path 5. In this case, the irradiation area 50 is in a state of extending in the direction orthogonal to the intersecting sections during its passage through the intersecting sections; and the irradiation area 50 is in a state of extending in a direction along the connecting sections during its passage through the connecting sections.

### 3. Effects

(1) According to the first and second embodiments, as the light source distance D1 increases, the moving speed of the irradiation area 50 is slowed down. This reduces overheating of a portion of the metal member 1 near the light source of the beam B and insufficient heating of a portion of the metal member 1 away from the light source of the beam B. In addition, as the ridgeline distance DO increases, the moving speed of the irradiation area 50 is slowed down. This reduces overheating of the portion of the metal member 1 near the ridgeline 20 and insufficient heating of the portion of the metal member 1 away from the ridgeline 20. Therefore, the present disclosure can help achieve more uniform heating during quenching, which can reduce an occurrence of a damage such as a burn-through in the metal member 1.

Furthermore, since the first and second embodiments can help achieve a partial quenching in a favorable manner, it is possible to form a member from high-tensile steel having a low tensile strength by press-forming and appropriately improve hardness of the member by subsequently quenching the member in accordance with the first and second embodiments. Therefore, although press-forming is difficult for ultra-high-tensile steel having a tensile strength of 1470 MPa or more, the first and second embodiments can help produce a member having a property similar to a member made of the ultra-high-tensile steel without use of the ultra-high-tensile steel, whereby the cost can be reduced.

(2) Still further, according to the first embodiment, the irradiation path 5 includes the two or more intersecting sections 51 and 52 that intersect the ridgeline 20. This can help achieve more uniform heating during quenching.

(3) Still further, according to the first embodiment, the size of the pitch P and the size of the irradiation area 50 are adjusted so that the first and second passage areas 54, respectively, formed in the adjacent first and second intersecting sections 51 and 52 overlap. Thus, the quenching area 4 can be more reliably heated.

(4) Still further, by changing the radiation direction of the beam B with the Galvano mirror 60, the irradiation area 50 moves through the intersecting sections 51 and 52. This allows the beam B to be radiated more favorably through the intersecting sections 51 and 52.

(5) Still further, each intersecting section 51 and 52 crosses the portion of the metal member 1 forming the effective width be. Since this can help achieve uniform heating of the portion forming the effective width be, the quenching can be performed while a damage of the metal member 1 is reduced.

### 4. Other Embodiments

(1) The metal member 1 as a whole according to the first and second embodiments is a plate-like part. However, the present disclosure is not limited hereto. In a method of manufacturing a metal member partially including the plate-like part, the quenching process may be performed on a ridgeline part and peripheral portions of the plate-like part as in the first and second embodiments. Furthermore, the quenching process as in the first and second embodiments may be performed on a ridgeline part and peripheral portions formed in a part of the metal member that is not in the form of a plate.

(2) In the first and second embodiments, the ridgeline part 2 and the ridgeline 20 extend linearly. However, the present disclosure is not limited hereto. The ridgeline part 2 and the ridgeline 20 formed in a bent shape may be provided with a quenching area, and quenching may be performed by radiating the beam B on the quenching area as in the first and second embodiments.

Specifically, in the case of setting the irradiation path including the two or more intersecting sections as in the first embodiment, the irradiation path may be arranged across the entire quenching area by aligning the intersecting sections substantially parallelly as in the first embodiment. In this case, the intersecting angle between each intersecting section and the ridgeline is not limited to approximately 90 degrees, and can be appropriately determined in accordance with the shape of the ridgeline. Needless to say, unlike the first embodiment, the irradiation path may be arranged across the entire quenching area by individually determining an orientation of each intersecting section in accordance with the shape of the ridgeline. In this case, all the intersecting sections are not necessarily in substantially parallel to one another. Moreover, the intersecting angle between each intersecting section and the ridgeline is not limited to approximately 90 degrees, and can be appropriately determined.

Furthermore, in the case of radiating the beam B having an irradiation area in an elongated shape as in the second embodiment, the beam B may be radiated across the entire quenching area by determining the shape of the irradiation area and the shape of the intersecting section in accordance with the shape of the ridgeline 20.

(3) In the first and second embodiments, the laser head 6 is arranged so that the light source of the beam B is positioned in front of the ridgeline 20 of the metal member 1. However, the present disclosure is not limited hereto. The position of the laser head 6 can be appropriately determined. Even in a case where the light source of the beam B is at a position different from the position in front of the ridgeline 20 of the metal member 1, the moving speed of the irradiation area 50 may be slowed down as the ridgeline distance DO increases and/or as the light source distance D1 increases.

(4) Two or more functions performed by a single element in the above embodiments may be achieved by two or more elements, and a single function performed by a single element may be achieved by two or more elements. Furthermore, two or more functions performed by two or more elements may be achieved by a single element, and a single function performed by two or more elements may be achieved by a single element. Still further, a part of a configuration in the above embodiments may by omitted. At least a part of the configuration in the above embodiments may be added to or replaced with another configuration in the above embodiments.

### 5. Technical Ideas Disclosed in Present Disclosure

### [Item 1]

A method of manufacturing a metal member comprising radiating a beam towards a ridgeline part in an outer surface of the metal member in order to perform quenching,
the ridgeline part extending along a ridgeline in the outer surface, the ridgeline part having a cross-section orthogonal to the ridgeline,
the cross-section of the ridgeline part having a shape such that the outer surface is bent in a protruding manner,
the ridgeline being located at a top in the cross-section,
an irradiation area, which is irradiated with the beam, moving on an irradiation path that passes through the ridgeline part,
the irradiation path including at least one intersecting section intersecting the ridgeline, and
a moving speed of the irradiation area being slowed down as a distance between the irradiation area and a light source of the beam increases.

### [Item 2]

A method of manufacturing a metal member comprising radiating a beam towards a ridgeline part in an outer surface of the metal member in order to perform quenching,
the ridgeline part extending along a ridgeline in the outer surface, the ridgeline part having a cross-section orthogonal to the ridgeline,
the cross-section of the ridgeline part having a shape such that the outer surface is bent in a protruding manner,
the ridgeline being located at a top in the cross-section,
an irradiation area, which is irradiated with the beam, moving on an irradiation path that passes through the ridgeline part,
the irradiation path including at least one intersecting section intersecting the ridgeline, and
a moving speed of the irradiation area being slowed down as a distance between the ridgeline and the irradiation area increases.

### [Item 3]

The method of manufacturing a metal member according to Item 1 or 2, wherein the irradiation path includes:
at least one first intersecting section included in the at least one intersecting section; and
at least one second intersecting section included in the at least one intersecting section,
wherein the at least one first intersecting section and the at least one second intersecting section are aligned alternately from a starting point to an ending point of the irradiation path,
wherein each first intersecting section of the at least one first intersecting section includes:
a first starting end located on right of the ridgeline; and
a first terminating end located on left of the ridgeline,
wherein each second intersecting section of the at least one second intersecting section includes:
a second starting end located on the left of the ridgeline; and
a second terminating end located on the right of the ridgeline,
wherein the irradiation area moves from the first starting end to the first terminating end of the each first intersecting section of the at least one first intersecting section, and moves from the second starting end to the second terminating end of each second intersecting section of the at least one second intersecting section,
wherein upon arriving at the first terminating end of a first intersecting section included in the at least one first intersecting section, the irradiation area moves to the second starting end of a second intersecting section included in the at least one second intersecting section that is adjacent to the first intersecting section on an ending point-side, and
wherein upon arriving at the second terminating end of the second intersecting section, the irradiation area moves to the first starting end of an other first intersecting section included in the at least one first intersecting section that is adjacent to the second intersecting section on the ending point-side.

### [Item 4]

The method of manufacturing a metal member according to Item 3,
wherein an area through which the irradiation area passes is defined as a passage area,
wherein the passage area includes:
a first passage area formed by the irradiation area passing through the first intersecting section; and
a second passage area formed by the irradiation area passing through the second intersecting section adjacent to the first intersecting section, and
wherein a size of the irradiation area, and a distance between the first intersecting section and the second intersecting section adjacent to each other are adjusted so that the first passage area and the second passage area overlap.

### [Item 5]

The method of manufacturing a metal member according to any one of Items 1 to 4,
wherein the irradiation area moves through the at least one intersecting section by changing a radiation direction of the beam with a mirror.

### [Item 6]

The method of manufacturing a metal member according to any one of Items 1 to 5,
wherein the ridgeline part is located in a plate-like part of the metal member, and
wherein the at least one intersecting section is provided so as to cross a portion of the plate-like part that forms an effective width.

### [Item 7]

The method of manufacturing a metal member according to any one of Items 1 to 6,
wherein the metal member is formed by press-forming, and
wherein the metal member is used for a body of a vehicle.

What is claimed is:

1. A method of manufacturing a metal member comprising radiating a beam towards a ridgeline part in an outer surface of the metal member in order to perform quenching,
the ridgeline part extending along a ridgeline in the outer surface, the ridgeline part having a cross-section orthogonal to the ridgeline,
the cross-section of the ridgeline part having a shape such that the outer surface is bent in a protruding manner,
the ridgeline being located at a top in the cross-section,
an irradiation area, which is irradiated with the beam, moving on an irradiation path that passes through the ridgeline part,
the irradiation path including at least one intersecting section intersecting the ridgeline, and
a moving speed of the irradiation area being slowed down as a distance between the irradiation area and a light source of the beam increases.

2. A method of manufacturing a metal member comprising radiating a beam towards a ridgeline part in an outer surface of the metal member in order to perform quenching,
the ridgeline part extending along a ridgeline in the outer surface, the ridgeline part having a cross-section orthogonal to the ridgeline,
the cross-section of the ridgeline part having a shape such that the outer surface is bent in a protruding manner,
the ridgeline being located at a top in the cross-section,
an irradiation area, which is irradiated with the beam, moving on an irradiation path that passes through the ridgeline part,
the irradiation path including at least one intersecting section intersecting the ridgeline, and
a moving speed of the irradiation area being slowed down as a distance between the ridgeline and the irradiation area increases.

3. The method of manufacturing a metal member according to claim 1,
wherein the irradiation path includes:
at least one first intersecting section included in the at least one intersecting section; and
at least one second intersecting section included in the at least one intersecting section,
wherein the at least one first intersecting section and the at least one second intersecting section are aligned alternately from a starting point to an ending point of the irradiation path,
wherein each first intersecting section of the at least one first intersecting section includes:
a first starting end located on right of the ridgeline; and
a first terminating end located on left of the ridgeline,
wherein each second intersecting section of the at least one second intersecting section includes:
a second starting end located on the left of the ridgeline; and
a second terminating end located on the right of the ridgeline,
wherein the irradiation area moves from the first starting end to the first terminating end of the each first intersecting section of the at least one first intersecting section, and moves from the second starting end to the second terminating end of each second intersecting section of the at least one second intersecting section,
wherein upon arriving at the first terminating end of a first intersecting section included in the at least one first intersecting section, the irradiation area moves to the second starting end of a second intersecting section included in the at least one second intersecting section that is adjacent to the first intersecting section on an ending point-side, and
wherein upon arriving at the second terminating end of the second intersecting section, the irradiation area moves to the first starting end of an other first intersecting section included in the at least one first intersecting section that is adjacent to the second intersecting section on the ending point-side.

4. The method of manufacturing a metal member according to claim 3,
wherein an area through which the irradiation area passes is defined as a passage area,
wherein the passage area includes:
a first passage area formed by the irradiation area passing through the first intersecting section; and
a second passage area formed by the irradiation area passing through the second intersecting section adjacent to the first intersecting section, and
wherein a size of the irradiation area, and a distance between the first intersecting section and the second intersecting section adjacent to each other are adjusted so that the first passage area and the second passage area overlap.

5. The method of manufacturing a metal member according to claim 3,
wherein the irradiation path includes:
two or more first intersecting sections as the at least one first intersecting section; and
two or more second intersecting sections as the at least one second intersecting section.

6. The method of manufacturing a metal member according to claim 3,
wherein the at least one first intersecting section and the at least one second intersecting section are aligned substantially parallelly with a substantially constant interval therebetween.

7. The method of manufacturing a metal member according to claim 1,
wherein the at least one intersecting section is substantially orthogonal to the ridgeline.

8. The method of manufacturing a metal member according to claim 1,
wherein the irradiation area moves through the at least one intersecting section by changing a radiation direction of the beam with a mirror.

9. The method of manufacturing a metal member according to claim 1,
wherein the ridgeline part is located in a plate-like part of the metal member, and
wherein the at least one intersecting section is provided so as to cross a portion of the plate-like part that forms an effective width.

10. The method of manufacturing a metal member according to claim 1,
wherein the metal member is formed by press-forming, and
wherein the metal member is used for a body of a vehicle.

11. The method of manufacturing a metal member according to claim 2,
wherein the irradiation path includes:
at least one first intersecting section included in the at least one intersecting section; and
at least one second intersecting section included in the at least one intersecting section,
wherein the at least one first intersecting section and the at least one second intersecting section are aligned alternately from a starting point to an ending point of the irradiation path,
wherein each first intersecting section of the at least one first intersecting section includes:
a first starting end located on right of the ridgeline; and
a first terminating end located on left of the ridgeline,
wherein each second intersecting section of the at least one second intersecting section includes:
a second starting end located on the left of the ridgeline; and
a second terminating end located on the right of the ridgeline,
wherein the irradiation area moves from the first starting end to the first terminating end of the each first intersecting section of the at least one first intersecting section, and moves from the second starting end to the second terminating end of each second intersecting section of the at least one second intersecting section,
wherein upon arriving at the first terminating end of a first intersecting section included in the at least one first intersecting section, the irradiation area moves to the second starting end of a second intersecting section included in the at least one second intersecting section that is adjacent to the first intersecting section on an ending point-side, and
wherein upon arriving at the second terminating end of the second intersecting section, the irradiation area moves to the first starting end of an other first intersecting section included in the at least one first intersecting section that is adjacent to the second intersecting section on the ending point-side.

12. The method of manufacturing a metal member according to claim 11,
wherein an area through which the irradiation area passes is defined as a passage area,
wherein the passage area includes:
a first passage area formed by the irradiation area passing through the first intersecting section; and
a second passage area formed by the irradiation area passing through the second intersecting section adjacent to the first intersecting section, and
wherein a size of the irradiation area, and a distance between the first intersecting section and the second intersecting section adjacent to each other are adjusted so that the first passage area and the second passage area overlap.

13. The method of manufacturing a metal member according to claim 11,
wherein the irradiation path includes:
two or more first intersecting sections as the at least one first intersecting section; and
two or more second intersecting sections as the at least one second intersecting section.

14. The method of manufacturing a metal member according to claim 11,
wherein the at least one first intersecting section and the at least one second intersecting section are aligned substantially parallelly with a substantially constant interval therebetween.

15. The method of manufacturing a metal member according to claim 2,
wherein the at least one intersecting section is substantially orthogonal to the ridgeline.

16. The method of manufacturing a metal member according to claim 2,
wherein the irradiation area moves through the at least one intersecting section by changing a radiation direction of the beam with a mirror.

17. The method of manufacturing a metal member according to claim 2,
wherein the ridgeline part is located in a plate-like part of the metal member, and
wherein the at least one intersecting section is provided so as to cross a portion of the plate-like part that forms an effective width.

18. The method of manufacturing a metal member according to claim 2,
wherein the metal member is formed by press-forming, and
wherein the metal member is used for a body of a vehicle.
